(19) United States
(12) Patent Application Publication
(10) Pub. No.: US 2016/0171519 A1
(43) Pub. Date: Jun. 16, 2016

(54) SYSTEM AND APPARATUS FOR PROVIDING OPTIMAL INFORMATION ABOUT PURCHASED PRODUCTS

(71) Applicant: SK PLANET CO., LTD., Seongnam-si (KR)

(72) Inventor: Sebyung KWAK, Seoul (KR)

(21) Appl. No.: 14/968,787

(22) Filed: Dec. 14, 2015

(30) Foreign Application Priority Data
Dec. 12, 2014 (KR) 1020140179515

(51) Int. Cl. G06Q 30/02

(52) U.S. Cl. CPC G06Q 30/0222

(57) ABSTRACT

Provided are a system and apparatus for providing optimal information about a purchased product. When optimal information about a product to be purchased is requested by a user terminal, an integrated management server receives product information and discount information of the product to be purchased from shopping mall servers associated with an ID of a user of the user terminal, calculate optimal information about the requested product based on the discount information, and then provide the calculated optimal information to the user terminal. Thus, the integrated management server may integratedly manage price comparison, payment cards, or discount rates/discount periods for each product with respect to a plurality of shopping malls to provide optimal payment information and product information.

### CROSS-REFERENCE TO RELATED APPLICATION

This application claims priority to and the benefit of Korean Patent Application No. 10-2014-0179515 filed in the Korean Intellectual Property Office on Dec. 12, 2014, the entire contents of which are incorporated herein by reference.

### TECHNICAL FIELD

The present invention relates to a system and apparatus for providing optimal information about purchased products, and more particularly, to a system and apparatus for providing optimal information about purchased products to provide optimal payment information and product information by performing identification (ID) association in an electronic commerce service and integratedly managing price comparison, payment cards, or discount rates/discount periods for each product with respect to a plurality of shopping malls.

### BACKGROUND

Along with the wide use of the Internet, product sellers has established virtual markets on the Internet, which is called Internet shopping malls, and Internet users can purchase specific desired products or goods through the virtual markets without directly visiting stores that sells the products or goods. The introduction of the Internet shopping malls can save time and cost caused by direct purchases of the users such as visit purchases or reserved purchases. Due to the merits of the Internet shopping malls, many users have used the Internet shopping mall and thus various Internet shopping malls such as a small office and home office (SOHO) mall have been introduced.

However, sales prices in the Internet shopping malls are different for each item, depending on Internet shopping mall companies. Thus, as more purchasers begin to desire to purchase products in the Internet shopping mall that presents the lowest price, price comparison websites have been introduced to check prices of one or more Internet shopping malls on the Internet and provide a list of the prices in the Internet shopping malls.

In a conventional price comparison service, when a user finds a desired product while doing online shopping through a web browser, the user accesses a product price comparison web server to obtain price comparison information about several web sites. The user searches this web site for price comparison information of the desired product, finds a shopping mall that provides the product at the lowest price, and then accesses the shopping mall to purchase the product.

However, such a conventional price comparison service system is merely a sorting service based on only the price. Although there are many other consideration factors in addition to the price when a product is purchased, the conventional price comparison service does not definitely sort price information for helping a direct purchase, but just disorderly lists the consideration factors.

### SUMMARY

The present invention is directed to providing a system and apparatus for providing optimal information about a purchased product by integratedly managing price comparison, payment cards, or discount rates/discount periods for each product with respect to a plurality of shopping malls to provide optimal payment information and product information.

One aspect of the present invention provides a user terminal including a communication unit configured to transmit and receive data in communication with an integrated management server; an output unit configured to output data by voice or to a screen; and a control unit configured to, when an input for checking optimal information about a product to be purchased is provided from a user, request the optimal information about the product from the integrated management server, receive the optimal information from the integrated management server, and output the received optimal information, in which the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

The optimal payment information may include at least one of minimum price information of the product and detailed information of a discount condition in which an optimal price is calculated.

The product information may include at least one of detailed information about the product to be purchased and information about shopping malls that sell the product to be purchased among the shopping malls associated with the ID of the user.

Another aspect of the present invention provides a shopping mall server including a shopping mall communication unit configured to transmit and receive data in communication with an integrated management server; a shopping mall storage unit configured to store at least one of product information, discount information, and user information; and a shopping mall control unit configured to, when product information and discount information of a specific product is requested by the integrated management server through the shopping mall communication unit, search for information stored in the shopping mall storage unit and transmit the requested product information and discount information of the product to the integrated management server through the shopping mall communication unit.

The discount information may be information about a discount condition of at least one of a card discount on each product, a discount rate for each product, a discount period, additional discount information, point membership, a coupon, and a gift certificate.

Still another aspect of the present invention provides an integrated management server including a server communication unit configured to transmit and receive data in communication with a user terminal or at least one shopping mall server; a server storage unit configured to store user information and shopping mall information; and a server control unit configured to, when optimal information about a product to be purchased is requested to be checked by the user terminal, check ID associated shopping malls for a user of the user terminal, request product information and discount information of the product from the checked shopping mall server through the server communication unit, receive the product information and discount information from the shopping mall server through the server communication unit, calculate optimal information about the requested product based on the discount information, and then transmit the calculated optimal information to the user terminal through the server communication unit, in which the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

The discount information may be information about a discount condition of at least one of a card discount on each product, a discount rate for each product, a discount period, additional discount information, point membership, a coupon, and a gift certificate.

Still another aspect of the present invention provides a system for providing optimal information about a purchased product, the system including a user terminal; at least one shopping mall server; and an integrated management server, in which the user terminal is configured to, when an input for checking optimal information about a product to be purchased is provided from a user, request the optimal information about the product from the integrated management server, receive the optimal information from the integrated management server, and output the received optimal information; the at least one shopping mall server is configured to, when product information and discount information of a specific product is requested by the integrated management server, transmit the requested product information and discount information of the product to the integrated management server; and the integrated management server is configured to, when optimal information about a product to be purchased is requested to be checked by the user terminal, check ID associated shopping malls for the user of the user terminal, request product information and discount information of the product from the checked shopping mall server, receive the product information and discount information from the shopping mall server, calculate optimal information about the requested product based on the discount information, and then transmit the calculated optimal information to the user terminal, in which the shopping mall server is a shopping mall server associated with the ID of the user of the user terminal.

Still another aspect of the present invention provides a method of providing optimal information about a purchased product, the method including, when an input for checking optimal information about a product to be purchased is provided from a user, requesting the optimal information about the product from an integrated management server, by a user terminal; when the optimal information is requested, checking an ID associated shopping mall for the user of the user terminal to request product information and discount information of the product from a checked shopping mall server, by the integrated management server; when product information and discount information of a specific product is requested by the integrated management server, transmitting the requested product information and discount information of the product to the integrated management server, by the shopping mall server; and when the product information and the discount information are received from the shopping mall server, calculating optimal information about the requested product based on the discount information and transmitting the calculated optimal information to the user terminal, by the integrated management server, in which the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

Still another aspect of the present invention provides a method of providing optimal information about a purchased product, the method including, when optimal information about a product to be purchased is requested to be checked by a user terminal, checking ID associated shopping malls for a user of the user terminal; requesting product information and discount information of the product from a checked shopping mall server; when the product information and discount information is received from the shopping mall server; calculating optimal information about the requested product based on the discount information and then transmitting the calculated optimal information to the user terminal, in which the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

The discount information may be information about a discount condition of at least one of a card discount on each product, a discount rate for each product, a discount period, additional discount information, point membership, a coupon, and a gift certificate.

The optimal payment information may include at least one of minimum price information of the product and detailed information of a discount condition in which an optimal price is calculated.

The product information may include at least one of detailed information about the product to be purchased and information about shopping malls that sell the product to be purchased among the shopping malls associated with the ID of the user.

According to the present invention, it is possible to provide the optimal payment information and product information by performing ID association in an electronic commerce service, integratedly managing price comparison, payment cards, or discount rates/discount periods for each product with respect to a plurality of shopping malls, and providing the optimal payment information and product information to integratedly analyze and manage different payment methods or different auxiliary payment discounts such as a card discount rate for each product, additional discount information, point membership, a coupon, and a gift certificate.

### BRIEF DESCRIPTION OF DRAWINGS

FIG. 1 is a block diagram showing a system for providing optimal information about a purchased product according to an embodiment of the present invention.

FIG. 2 is a block diagram showing a user terminal in an optimal information providing system according to an embodiment of the present invention.

FIG. 3 is a block diagram showing a shopping mall server in an optimal information providing system according to an embodiment of the present invention.

FIG. 4 is a block diagram showing an integrated management server in an optimal information providing system according to an embodiment of the present invention.

FIG. 5 is an exemplary diagram showing user information stored in an integrated management server according to an embodiment of the present invention.

FIG. 6 is an exemplary diagram showing optimal information provided according to an embodiment of the present invention.

FIG. 7 is a sequence diagram showing a method of providing optimal information in an optimal information providing system according to an embodiment of the present invention.

FIG. 8 is a flowchart showing a method of providing optimal information in an integrated management server according to an embodiment of the present invention.

### DETAILED DESCRIPTION

In the following description, detailed descriptions of well-known functions or constructions will be omitted since they would obscure the invention in unnecessary detail. In addition, it should be noted that like reference numerals denotes like elements throughout the specification and drawings.

It should be understood that the terms used in the specification and the appended claims should not be construed as limited to general and dictionary meanings, but interpreted based on the meanings and concepts corresponding to technical aspects of the present invention on the basis of the principle that the inventor is allowed to define terms appropriately for the best explanation. Therefore, the description proposed herein is just a preferable example for the purpose of illustrations only, not intended to limit the scope of the invention, so it should be understood that other equivalents and modifications could be made thereto without departing from the spirit and scope of the invention.

Hereinafter, exemplary embodiments of the present invention will be described in detail with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out. The following detailed description includes detailed matters to provide full understanding of the present invention. However, it will be apparent to those skilled in the art that the present invention can be carried out without the detailed matters.

In some cases, to prevent the concept of the present invention from being ambiguous, structures and apparatuses of the known art will be omitted, or will be shown in the form of a block diagram based on main functions of each structure and apparatus.

Furthermore, when one part is referred to as “comprising (or including or having)” other elements, it should be understood that it can comprise (or include or have) only those elements, or other elements as well as those elements unless specifically described otherwise. Moreover, each of terms such as “unit,” “part,” and “module” described in the specification denotes an element for performing at least one function or operation, and may be implemented in hardware, software or a combination of hardware and software. The use of the terms “a” or “an,” “one” and “the” and similar referents in the context of describing embodiments (especially in the context of the following claims) are to be construed to cover both the singular and the plural, unless otherwise stated or the context clearly indicates otherwise.

In addition to the above-described terms, specific terms used herein are provided to help understanding of the present invention, and the use of those specific terms may be replaced with other terms without departing from the technical concept of the present invention.

A system for providing optimal information about a purchased product according to an embodiment of the present invention will be described below.

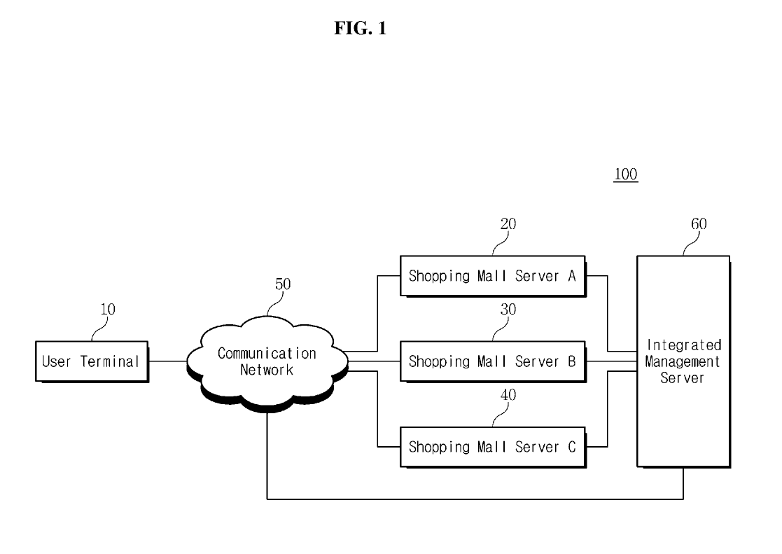

FIG. 1 is a block diagram showing a system for providing optimal information about a purchased product according to an embodiment of the present invention.

Referring to FIG. 1, a system 100 for providing optimal information about a purchased product according to an embodiment of the present invention includes a user terminal 10, at least one or more shopping mall servers 20, 30, and 40, an integrated management server 60, and a communication network 50.

Each processor installed in the user terminal 10, the shopping mall servers 20, 30, and 40, and the integrated management server 60 may process program instructions for executing the method according to an embodiment of the present invention. In one implementation, the processor may be a single-threaded processor. In alternative implementations, the processor may be a multithreaded processor. Furthermore, the processor may also process instructions stored in a memory or a storage device.

The communication network 50 performs a series of data transceiving operations for transferring data and exchange information among the user terminal 10, the shopping mall servers 20, 30, and 40, and the integrated management server 60. In particular, the communication network 50 may include various communication networks, e.g., wireless communication schemes such as wireless LAN (WLAN), Wi-Fi, Wibro, Wimax, and high speed downlink packet access (HSDPA) and wired communication schemes such as Ethernet, xDSL (ADSL, VDSL), hybrid fiber coax (HFC), fiber to the curb (FTTC), and fiber to the home (FTTH). The communication network 50 is not limited to the above-described communication schemes, and may include other communication schemes that are widely known or will be developed in the future.

The user terminal 10 communicates with the shopping mall servers 20, 30, and 40 and the integrated management server 60 over the communication network 50 to transmit or receive data for providing optimal information about a purchased product.

In particular, when an input for checking optimal information about a product to be purchased is received from a user, the user terminal 10 according to an embodiment of the present invention requests the optimal information about a specific product from the integrated management server 60, receives the optimal information from the integrated management server 60, and outputs the received optimal information.

Here, the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate. In addition, the optimal payment information includes at least one of minimum price information of the product and detailed information of a discount condition in which an optimal price is calculated, and the product information includes at least one of detailed information about the product to be purchased and information about shopping malls that sell the product among the shopping malls associated with the ID of the user.

When product information and discount information of a specific product are requested by the integrated management server 60, the shopping mall servers 20, 30, and 40 transmit the product information and discount information of the requested product to the integrated management server 60. Here, the discount information denotes information about the discount condition of the at least one of the card discount on each product, discount rate for each product, discount period, additional discount information, point membership, coupon, and gift certificate.

When the optimal information about the product to be purchased is requested to be checked by the user terminal 10, the integrated management server 60 checks ID associated shopping malls for the user of the user terminal 10. In this case, when servers for the checked shopping malls are the shopping mall servers 20, 30, and 40, the integrated management server 60 requests the product information and discount information of the product to the shopping mall servers 20, 30, and 40. Subsequently, when the product information and the discount information are received from the shopping mall servers 20, 30, and 40, the integrated management server 60 calculates optimal information about the requested product on the basis of the discount information and transmits the calculated optimal information to the user terminal 10. Here, the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

A configuration of the user terminal in the above-described optimal information providing system according to an embodiment of the present invention will be described in detail below.

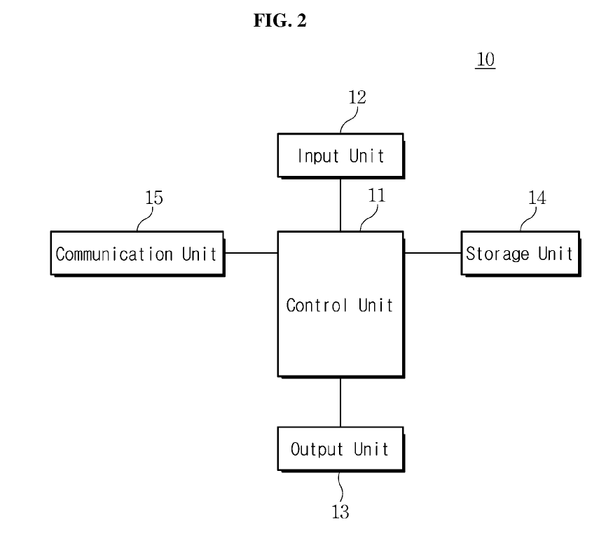

FIG. 2 is a block diagram showing a configuration of a user terminal according to an embodiment of the present invention.

Referring to FIG. 2, the user terminal 10 according to an embodiment of the present invention includes a control unit 11, an input unit 12, an output unit 13, a storage unit 14, and a communication unit 15.

The input unit 12 receives a variety of information such as number and character information and delivers a signal that is received in relation to setting and controlling various functions of the terminal 10 to the control unit 11. In addition, the input unit 12 may include at least one of a keypad and a touchpad, which generate an input signal according to a touch or manipulation of a user. Here, the input unit 12 may be configured as one touch panel (or touch screen) together with the output unit 13 and perform an input function and also a display function. For example, the input unit 12 may include any type of input means to be developed in the future, in addition to an input device such as a keyboard, a keypad, a mouse, and a joystick. In particular, the input unit 12 according to an embodiment of the present invention senses an input signal that is entered by the user and needed to receive the optimal information about the purchased product and delivers the sensed input signal to the control unit 11.

The output unit 13 includes a display unit (not shown) that displays information about a series of operation states and an operation result, which are generated while the functions of the user terminal 10 are performed, and a speaker SPK that reproduces and outputs an audio signal or an audio processing unit (not shown) that performs a function of delivering an audio signal input from a microphone MIC to the control unit 11.

First, the display unit may display a menu of the user terminal 10, user data entered by the user, etc. Here, the output unit 13 may include a liquid crystal display (LCD), a thin film transistor LCD (TFT-LCD), a light emitting diode (LED), an organic light emitting diode (OLED), an active matrix organic LED (AMOLED), a retina display, a flexible display, and a three-dimensional display. In this case, when the output unit 13 is configured in the form of a touch screen, the output unit 13 may perform some or all of the functions of the input unit 12. In particular, the output unit 13 according to an embodiment of the present invention outputs optimal information about a purchased product to a screen, etc.

In addition, the audio processing unit may convert an analog audio signal that is input through the microphone into a digital audio signal and deliver the digital audio signal to the control unit 11. In addition, the audio processing unit may convert the digital audio signal output from the control unit 11 into an analog signal and output the analog signal through the speaker. In particular, the audio processing unit according to an embodiment of the present invention outputs sound effects or execution sounds that are generated while the optimal information about the purchased product is provided.

The storage unit 14 is a device for storing data, including a main memory device and an auxiliary memory device, and stores an application program needed to operate the functions of the user terminal 10. The storage unit 14 may largely include a program area and a data area. Here, when each function is activated corresponding to a user's request, the user terminal 10 executes a corresponding application program under the control of the control unit 11 to provide the function. In particular, the storage unit 14 according to an embodiment of the present invention stores a program for checking an operating system that boots the user terminal 10 and a program for receiving the optimal information about the purchased product.

The communication unit 15 performs a function of transmitting and receiving data for providing the optimal information about the purchased product through the communication network 50. Here, the communication unit 15 includes an RF transmitting part that up-converts a frequency of a transmitted signal and amplifies the transmitted signal, an RF receiving part that low-noise-amplifies a received signal and down-converts a frequency of the received signal, etc. The communication unit 15 may include at least one of a wireless communication module (not shown) and a wired communication module (not shown). The wireless communication module is configured to transmit and receive data according to a wireless communication method. When the user terminal 10 utilizes wireless communication, the user terminal 10 may use any one of a wireless network communication module, a wireless LAN communication module, and a wireless PAN communication module to transmit and receive data to and from the shopping mall servers 20, 30, and 40 and the integrated management server 60. The wired communication module is used to transmit and receive the data in a wired manner. The wired communication module may access the communication network 50 in a wired manner to transmit and receive the data to the shopping mall servers 20, 30, and 40 and the integrated management server 60.

The control unit 11 may be responsible for the overall control of the user terminal 10 and may be a process device that drives an operating system (OS) and elements.

In particular, when an input for checking optimal information about a product to be purchased is received from the user, the control unit 11 according to an embodiment of the present invention requests the optimal information about the specific product to the integrated management server 60 through the communication unit 15. Subsequently, when the optimal information is received from the integrated management server 60 through the communication unit 15, the control unit 11 outputs the optimal information through the output unit 13.

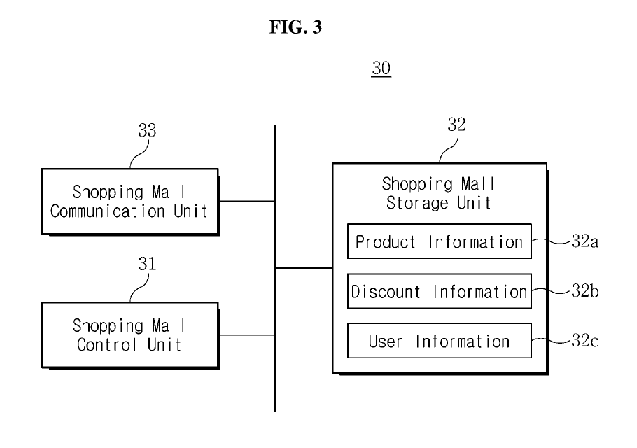

FIG. 3 is a block diagram showing a shopping mall server in an optimal information providing system according to an embodiment of the present invention.

Referring to FIG. 3, each of the shopping mall servers 20, 30, and 40 according to an embodiment of the present invention includes a shopping mall control unit 31, a shopping mall storage unit 32, and a shopping mall communication unit 33.

The shopping mall communication unit 33 communicates with the user terminal 10 and the integrated management server 60 through the communication network 50 to transmit and receive data.

The shopping mall storage unit 32 is used to store data needed to operate the shopping mall servers 20, 30, and 40. Here, the shopping mall storage unit 32 includes and stores product information 32a, discount information 32b, and user information 32c. Here, the product information denotes detailed information about the product, and the discount information denotes information about the discount condition of the at least one of the card discount on each product, discount rate for each product, discount period, additional discount information, point membership, coupon, and gift certificate. In addition, the user information denotes user information registered when joining the shopping mall.

The shopping mall control unit 31 is configured to perform the overall control of the shopping mall servers 20, 30, and 40 and control a signal flow for performing functions of the shopping mall communication unit 33 and the shopping mall storage unit 32.

In detail, when the product information and discount information of the specific product are requested through the shopping mall communication unit 33 from the integrated management server 60 by the user terminal 10, the shopping mall control unit 31 searches for information stored in the shopping mall storage unit 32, checks the requested production information and discount information of the product, and transmits the checked production information and discount information to the integrated management server 60 through the shopping mall communication unit 33.

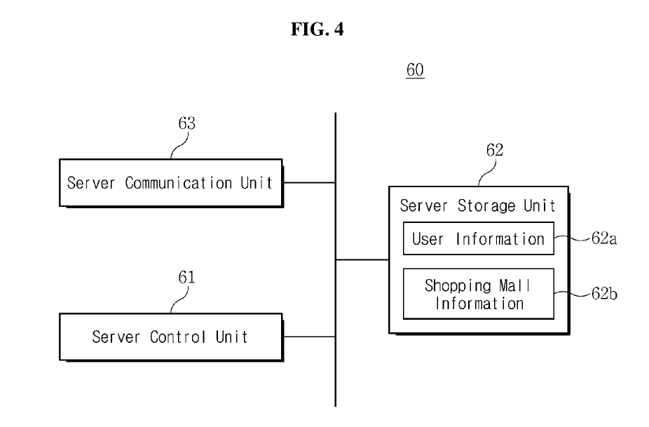

FIG. 4 is a block diagram showing an integrated management server in an optimal information providing system according to an embodiment of the present invention.

First, referring to FIG. 4, the integrated management server 60 according to an embodiment of the present invention includes a server control unit 61, a server storage unit 62, and a server communication unit 63. Here, the server storage unit 62 includes user information 62a and shopping mall information 62b.

The server communication unit 63 communicates with the user terminal 10 and the shopping mall servers 20, 30, and 40 through the communication network 50 to transmit and receive data for providing optimal information about a product to be purchased.

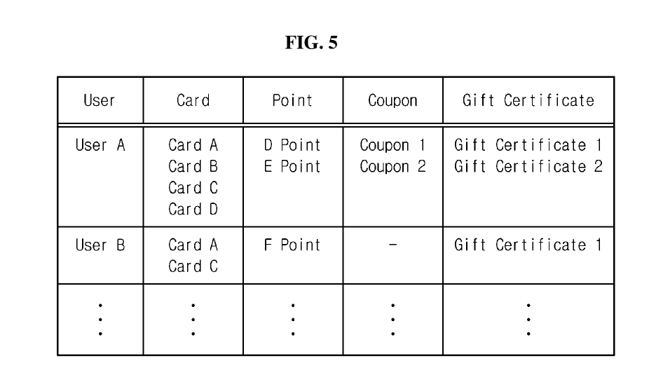

The server storage unit 62 stores all programs and data according to execution of functions of the integrated management server 60. In particular, the server storage unit 62 according to an embodiment of the present invention stores the user information 62a and the shopping mall information 62b. In this case, as shown in FIG. 5, the user information 62a contains payment methods, such as a payment cart, a point, a coupon, and a gift certificate, which are to be used by the user. In addition, the shopping mall information 62b denotes information about ID associated shopping malls for each user.

The server control unit 61 may be a process device that drives an operating system and elements. In particular, when the optimal information about the product to be purchased is requested to be checked by the user terminal 10, the server control unit 61 according to an embodiment of the present invention checks the ID associated shopping malls for the user of the user terminal 10. Subsequently, the server control unit 61 requests product information and discount information of the product from the checked shopping mall server through the server communication unit 63.

Subsequently, when the product information and the discount information are received from the shopping mall servers through the server communication unit 63, the server control unit 61 calculates optimal information about the requested product on the basis of the discount information and then transmits the calculated optimal information to the user terminal 10 through the server communication unit 63. Here, the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

Here, the discount information is information about the discount condition of the at least one of the card discount on each product, discount rate for each product, discount period, additional discount information, point membership, coupon, and gift certificate.

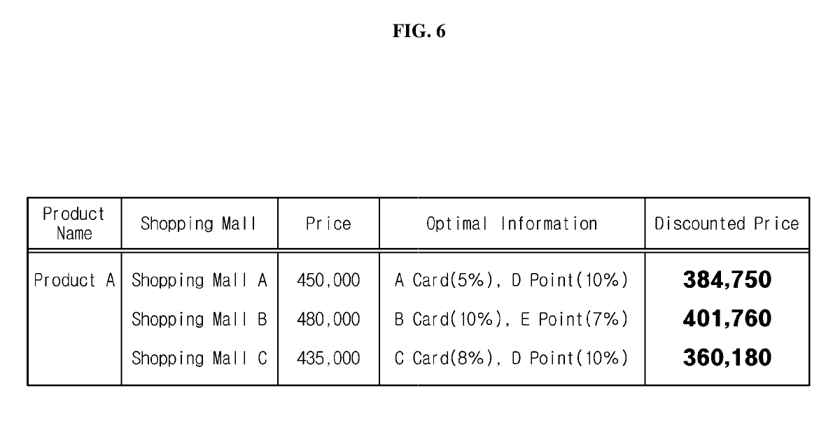

The optimal information transmitted to the user terminal may be provided as shown in FIG. 6. Referring to FIG. 6, shopping malls to which an ID associated service of the user is applied are shopping mall A, shopping mall B, and shopping mall C. When payment is made in shopping mall A with card A and point D, the price is 384,750 won. When payment is made in shopping mall B with card B and point E, the price is 401,760 won. When payment is made in shopping mall C with card C and point D, the price is 360,180 won. FIG. 6 shows only a case in which the payment is made only with cards and points. However, in addition to the card discount on each product and the point discount, the optimal information may be provided by applying a discount condition for each shopping mall of at least one of a discount rate for each product, a discount period, additional discount information, a coupon, and a gift certificate.

The above-described integrated management server 60 may be implemented as one or more servers that operate in a server-based computing scheme or a cloud computing scheme. In particular, data needed to provide the optimal information about the product to be purchased may be provided through a cloud computing function in which the data may be permanently stored in a cloud computing device on the Internet. Here, the cloud computing denotes technology for servicing information technology (IT) resources virtualized by utilizing Internet technology, such as hardware (e.g., a server, a storage, and a network), software (e.g., database, security, and web server), service, data and the like in an on demand scheme, to a digital terminal such as a desktop, a tablet computer, a laptop, a netbook and a smartphone as described above.

Memories are installed in the user terminal 10, the shopping mall servers 20, 30, and 40, and the integrated management server 60 to store information therein. In an implementation, each memory is a computer-readable medium. In an implementation, the memory may be a volatile memory unit. In another implementation, the memory may be a non-volatile memory unit. In an implementation, a storage device is a computer-readable medium. In various other implementations, the storage device may include, for example, a hard disk device, an optical disk device, or any other mass storage device.

Although an exemplary configuration of the apparatus has been described herein, implementations of the subject matter and the functional operations described in this specification can be implemented in other types of digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program storage medium for execution by, or to control the operation of, an apparatus according to the present invention. The computer-readable medium can be a machine-readable storage device, a machine-readable storage substrate, a memory device, a composition of matter affecting a machine-readable propagated signal, or a combination of one or more of them.

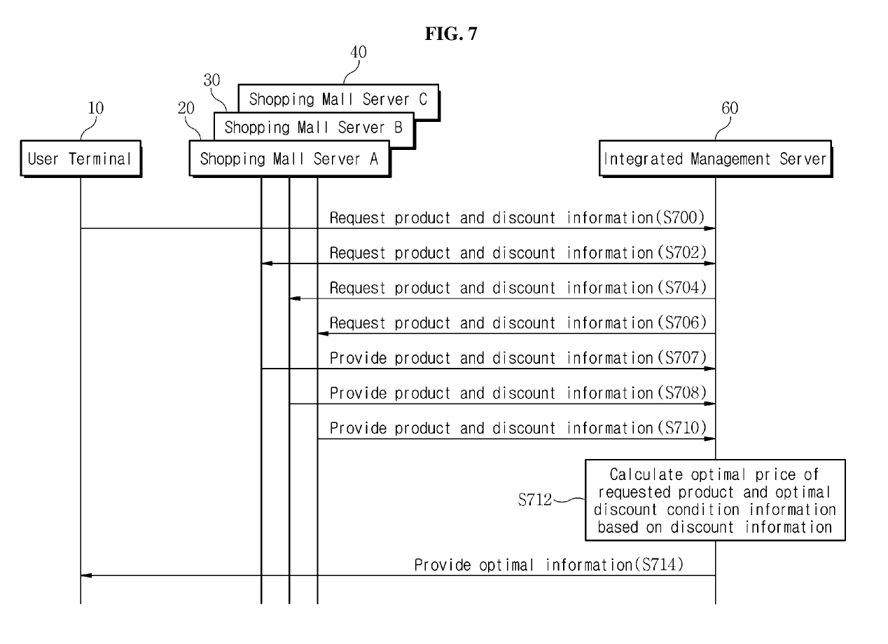

FIG. 7 is a sequence diagram showing a method of providing optimal information in an optimal information providing system according to an embodiment of the present invention.

It is assumed that this process is performed after an operation for accessing an integrated management server 60 through a user terminal of a user, in order for the user to receive optimal information about a product to be purchased. It is also assumed that the user is a user who receives an ID associated service from shopping mall servers 20, 30, and 40.

When product price information is requested by the user, the user terminal 10 requests optimal information about a corresponding product from the integrated management server 60 (S700).

The integrated management server 60 checks information about ID associated shopping malls through user information of the user terminal 10 and then requests product information and discount information of the corresponding product from the checked shopping mall servers 20, 30, and 40 (S702, S704, and S706).

Upon receiving the request of the product information and discount information of the product, the shopping mall servers 20, 30, and 40 provide the requested information to the integrated management server 60 (S708, S710, and S710). Here, the product information includes price information of the product. In addition, the discount information includes at least one of information about payment cards for discounts on the product, information about discount rates/discount periods, affiliate coupon information, point membership information, and gift certificate information.

Next, when the product information and discount information are received from all of the ID associated shopping mall servers 20, 30, and 40, the integrated management server 60 calculates information about an optimal price and an optimal discount condition for the requested product on the basis of the discount information (S712).

For example, a case in which a discount is received from shopping mall A by payment with card A (5%) and point D (additional 10%), a case in which a discount is received from shopping mall B by payment with card B (10%) and point E (7%), and a case in which a discount is received from shopping mall C by payment with card C (8%) and point D (10%) are analyzed for product T. Here, the integrated management server 60 provides the optimal price information and the optimal discount condition information on the basis of card payment discount rates and auxiliary payment discount rates for product T (S714).

Subsequently, the integrated management server 60 transmits the calculated optimal information to the user terminal 10.

According to an embodiment of the present invention, it is possible to provide the optimal payment information and product information by integratedly managing price comparison, payment cards, or discount rates/discount periods for each product with respect to a plurality of shopping malls, in particular, by integratedly managing different payment methods or different card discount rates and auxiliary payment discounts.

Thus, it is possible to provide an optimal product and an optimal payment method by integratedly managing discount rates of payment methods (main payment/auxiliary payment) for each product in addition to the price comparison.

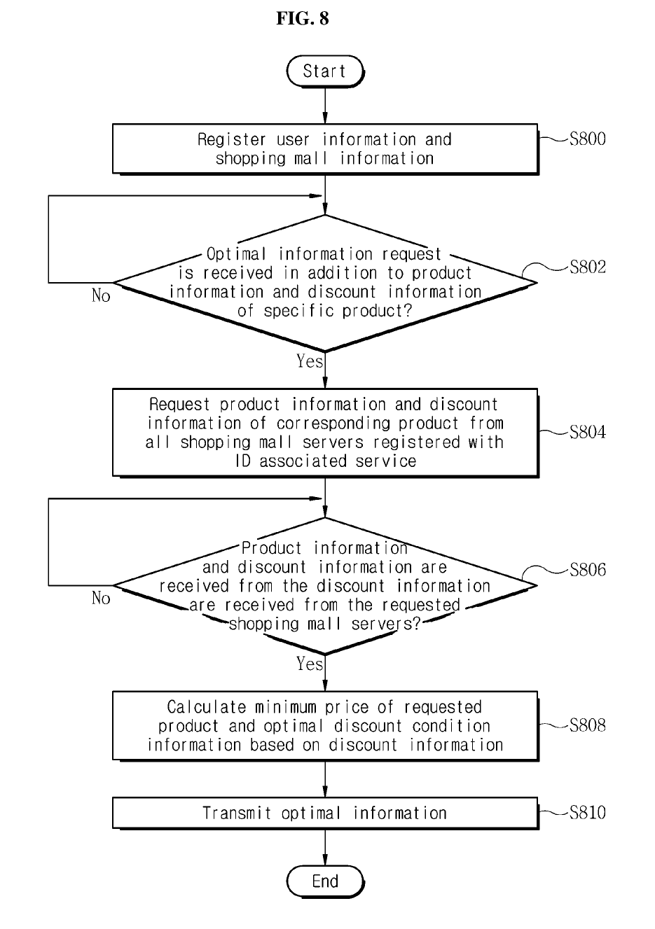

FIG. 8 is a flowchart showing a method of providing optimal information in an integrated management server according to an embodiment of the present invention.

The integrated management server 60 registers user information and shopping mall information (S800). In this case, the user information includes a user's ID. In addition, the shopping mall information denotes information about ID associated shopping malls for each ID.

When an optimal information request is received from the user terminal 10 in addition to product information and discount information about a specific product (S802), the integrated management server 60 checks information about ID associated shopping malls through user information of the user terminal 10 and then requests the product information and discount information of the corresponding product from the checked shopping mall servers (S804).

Subsequently, the integrated management server 60 receives the requested information from the shopping mall servers that have received the request of the product information and discount information of the specific product (S806). Here, the product information includes price information of the product. In addition, the discount information includes at least one of information about payment cards for discounts on the product, information about discount rates/discount periods, affiliate coupon information, point membership information, and gift certificate information.

Next, when the product information and discount information are received from all of the ID associated shopping mall servers, the integrated management server 60 calculates information about an optimal price and an optimal discount condition for the requested product on the basis of the discount information (S808).

Subsequently, the integrated management server 60 transmits the optimal information to the user terminal 10 (S810).

Various techniques described herein can be implemented in digital electronic circuitry, or in computer hardware, firmware, software, or in combinations thereof. The techniques can be implemented as a computer program product, i.e., a computer program tangibly embodied in an information carrier, e.g., in a machine-readable storage device (computer-readable medium) or in a propagated signal, for execution by, or to control the operation of, a data processing apparatus, e.g., a programmable processor, a computer, or multiple computers. A computer program such as the computer program(s) described above can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps can be performed by one or more programmable processors executing one or more computer programs to perform the functions by operating on input data and generating output. The method steps can also be performed by, and an apparatus can also be implemented as, special purpose logic circuitry, e.g., a field programmable gate array (FPGA) or an application-specific integrated circuit (ASIC).

Processors suitable for the execution of a computer program include, by way of example, both general and special purpose microprocessors, and any one or more processors of any kind of a digital computer. Generally, a processor will receive instructions and data from a read-only memory or a random access memory or both. The elements of a computer may include at least one processor for executing instructions and one or more memory devices for storing instructions and data. Generally, a computer will also include, or be operatively coupled to receive data from or transfer data to, or both, one or more mass storage devices for storing data, e.g., magnetic disks, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc., magneto-optical media such as a floptical disk, and a read only memory (ROM), a random access memory (RAM), a flash memory, an erasable programmable ROM (EPROM), and an electrically erasable programmable ROM (EEPROM). A processor and a memory may be supplemented by, or integrated into, a special purpose logic circuit.

While this specification contains many specifics, these should not be construed as limitations on the scope of what being claims or of what may be claimed, but rather as descriptions of features specific to particular embodiments. Features described in the specification in the context of individual embodiments may be implemented as a combination in a single embodiment. In contrast, features described in the specification in the context of a single embodiment may be implemented in multiple embodiments individually or in an appropriate sub-combination. Furthermore, the features may operate in a certain combination and may be initially described as claimed in the combination, but one or more features may be excluded from the claimed combination in some cases, and the claimed combination may be changed into a sub-combination or a modification of a sub-combination.

Similarly, even though operations are described in a certain order on the drawings, it should not be understood that the operations be executed in the certain order or in a sequential order to obtain desired results, or that all the operation be executed. In some cases, multitasking and parallel processing may be beneficial. In addition, it should not be understood that the separation of various system components in the above described embodiments is required in all embodiments, and it should be understood that the above described program components and systems may be incorporated into a single software product or may be packaged in multiple software products.

It should be understood that the embodiments disclosed herein are merely illustrative and are not intended to limit the scope of the invention. Although specific embodiments have been illustrated and described herein, it is obvious to those skilled in the art that many modifications of the present invention may be made without departing from what is intended to be limited solely by the appended claims.

### INDUSTRIAL APPLICABILITY

The present invention relates to a system and apparatus for providing optimal information about purchased products, and more particularly, to a system and apparatus for providing optimal information about purchased products to provide optimal payment information and product information by performing identification (ID) association in an electronic commerce service and integratedly managing price comparison, payment cards, or discount rates/discount periods for each product with respect to a plurality of shopping malls. Moreover, the present invention has industrial applicability in that the possibility of sales or business is sufficient and also actually the present invention may be carried out.

What is claimed is:

1. A user terminal comprising:
a communication unit configured to transmit and receive data in communication with an integrated management server;
an output unit configured to output data by voice or to a screen; and
a control unit configured to, when an input for checking optimal information about a product to be purchased is provided from a user, request the optimal information about the product from the integrated management server, receive the optimal information from the integrated management server, and output the received optimal information,
wherein the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

2. The user terminal of claim 1, wherein the optimal payment information includes at least one of minimum price information of the product and detailed information of a discount condition in which an optimal price is calculated.

3. The user terminal of claim 1, wherein the product information includes at least one of detailed information about the product to be purchased and information about shopping malls that sell the product to be purchased among the shopping malls associated with the ID of the user.

4. A shopping mall server comprising:
a shopping mall communication unit configured to transmit and receive data in communication with an integrated management server;
a shopping mall storage unit configured to store at least one of product information, discount information, and user information; and
a shopping mall control unit configured to, when product information and discount information of a specific product is requested by the integrated management server through the shopping mall communication unit, search for information stored in the shopping mall storage unit and transmit the requested product information and discount information of the product to the integrated management server through the shopping mall communication unit.

5. The shopping mall server of claim 4, wherein the discount information is information about a discount condition of at least one of a card discount on each product, a discount rate for each product, a discount period, additional discount information, point membership, a coupon, and a gift certificate.

6. An integrated management server comprising:
a server communication unit configured to transmit and receive data in communication with a user terminal or at least one shopping mall server;
a server storage unit configured to store user information and shopping mall information; and
a server control unit configured to, when optimal information about a product to be purchased is requested to be checked by the user terminal, check ID associated shopping malls for a user of the user terminal, request product information and discount information of the product from the checked shopping mall server through the server communication unit, receive the product information and discount information from the shopping mall server through the server communication unit, calculate optimal information about the requested product based on the discount information, and then transmit the calculated optimal information to the user terminal through the server communication unit,
wherein the optimal information is price comparison information about shopping malls associated with an ID of the user and includes optimal payment information and product information obtained by performing integrated analysis in consideration of a discount condition of at least one of a card discount on each product, a discount rate for each product, a discount period, additional discount information, point membership, a coupon, and a gift certificate.

7. The integrated management server of claim 6, wherein the discount information is information about a discount condition of at least one of a card discount on each product, a discount rate for each product, a discount period, additional discount information, point membership, a coupon, and a gift certificate.

8. The integrated management server of claim 6, wherein the optimal payment information includes at least one of minimum price information of the product and detailed information of a discount condition in which an optimal price is calculated.
